(19) United States
(12) Patent Application Publication
(10) Pub. No.: US 2006/0288629 A1
(43) Pub. Date: Dec. 28, 2006

(54) Illuminated fishing pole

(76) Inventors: Kenneth Harvey Parker, Livingston, TX (US); Julia Faye Parker, Livingston, TX (US)

Correspondence Address: Delphine James, Suite 170, 2656 South Loop West, Houston, TX, 77054, US

(21) Appl. No.: 11/140,244

(22) Filed: May 27, 2005

(51) Int. Cl. A01K 87/00

(52) U.S. Cl. 43/17.5; 43/18.1 R

(57) ABSTRACT

The present invention is an illuminated fishing rod. The illuminated rod further comprises an elongated shaft having a tip portion at one end and a handle at the opposite end. A compartment is internally integrated within the handle. The compartment is adapted to receive a power source and a light source. A plurality of eyelet guide members is mounted upon the longitudinal axis from the proximal end to the distal end of the shaft. A bundle of optical fibers are operationally mounted within the elongated shaft. The light source is operationally connected to the optical fibers for illuminating the shaft, and the power source is operationally connected to the light source to generate power for the light source to illuminate the shaft. In an alternative embodiment, the bundle of optical fibers is operationally mounted along the external surface of the elongated shaft. In another embodiment, the elongated shaft is segmented into multiple sections for easy storage.

### BACKGROUND

The present invention relates to a fishing rod and, in particular, to a fishing rod that is illuminated by optical fibers.

Fishing is one of the most popular recreational activities. Men, women, and children of all ages worldwide enjoy it. Literally millions of people fish on the waterways of their nation. Fresh-water and salt-water fish are sought for food and for the enjoyment of the sport. Many people use a variety of water-craft to reach the best fishing locations, while fishing from the banks of a watercourse or waterway is preferred by other people.

Regardless of the purpose for fishing or the location of the pursuit, people who fish make use of a variety of different types of equipment in fulfilling their goals. However, one central piece of fishing equipment is the fishing rod. Fishing rods are created in different sizes, shapes, and style each with their own purpose and function. Fly fish rods and spinning rods along with standard rods designed for the traditional open-reel are the three primary type's fishing rod types.

However, it would be advantageous to have a fishing rod that was illuminated by optical fibers. This would allow a person fishing at night or other low-light scenarios to have a better view of their fishing rod and associated components. Furthermore, a fishing rod illuminated by optical fibers could emit light to the area being fished enabling the user to have a clearer view of the total scene and thus, allowing the user to fish more skillfully and safely. The present invention provides such a fishing rod.

### SUMMARY

The present invention provides an illuminated fishing rod comprising an elongated shaft having a tip portion at a first end and a handle at the opposite second end, the shaft having an internal bore. A compartment is situated within the handle which is adapted to receive a power source and a light source. The light source is operationally connected to the power source which supplies the power to the light source. A plurality of circular hollow eyelet guide members is externally mounted along the longitudinal axis of the shaft. A bundle of optical fibers is operationally connected inside the bore of the shaft extending from the first end to the opposite second end. An aperture is located below each guide member for receiving therethrough at least one optical strand from the bundle. The at least one strand extends through the guide member for the illumination thereof. In one embodiment, the bundle of fibers can be connected to the external surface of the shaft. In another embodiment, the shaft can be segmented into a plurality of sections. The main objective of the present invention is to provide a new and improved illuminated fishing rod.

### BRIEF DESCRIPTION OF DRAWINGS

FIG. 1 illustrates a frontal view of the present invention.

FIG. 1A is an exploded view of eyelet guide member

FIG. 2 is a frontal view of the present invention showing the handle separated from the main shaft of the pole.

FIG. 2A is an exploded view of the eyelet guide member showing the internal conduits housing the fiber optic strands

FIG. 3 is a frontal view illustrating the handle decoupled from the rod into a flashlight.

FIG. 4 is a frontal view illustrating the shaft in segmented components.

FIG. 4A illustrates the fiber optic coupler for the segmented shaft.

FIGS. 5A, 5B, and 5C illustrates the eyelet member connection to the fishing rod.

FIG. 6 is a frontal view illustrating the extension rod in the shaft.

FIG. 7 is a frontal view illustrating the mini-flashlight.

FIG. 8 is a frontal view illustrating the laser light and magnifying guide members.

FIGS. 9 and 9A is a block diagram illustrating the sensor and override switch connection with the solar panel assembly.

### DETAILED SPECIFICATION

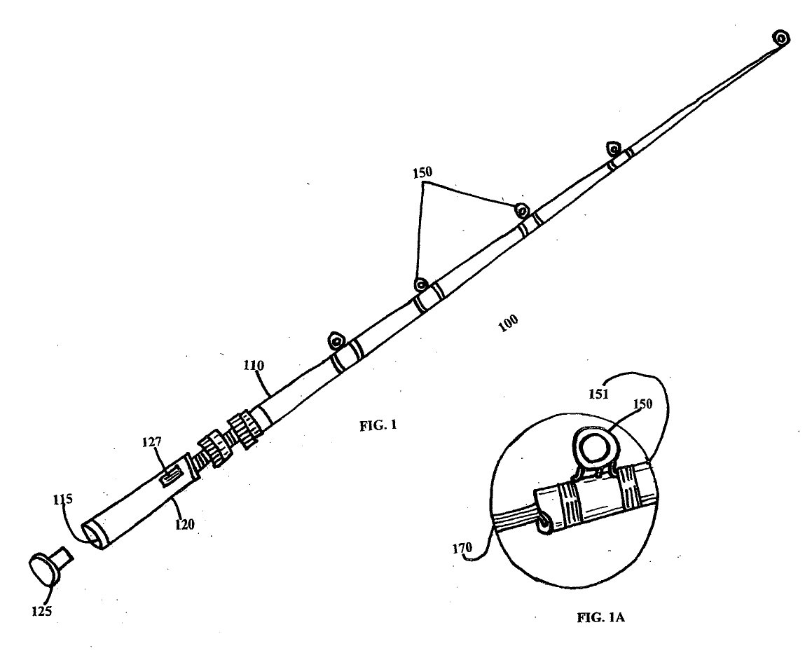

Referring to FIG. 1, there is shown a side perspective view of one embodiment of the present invention. The present invention provides a new and improved fishing rod (100) that is illuminated through the use of fiber optic technology. The shaft (110) of the rod may be constructed of any suitable lightweight, rigid material such as plastic, metal, fiberglass, graphite, and so on. Any metal used could be selected from steel, or alloys of steel and aluminum. Any plastic used should be selected for its durability and long wearing traits. Thermoplastics such as polyethylene, polypropylene, nylon, and so on possess such traits. In the preferred embodiment, the selected materials should have high impact strength and be able to accept and retain coloring materials for an extended length of time.

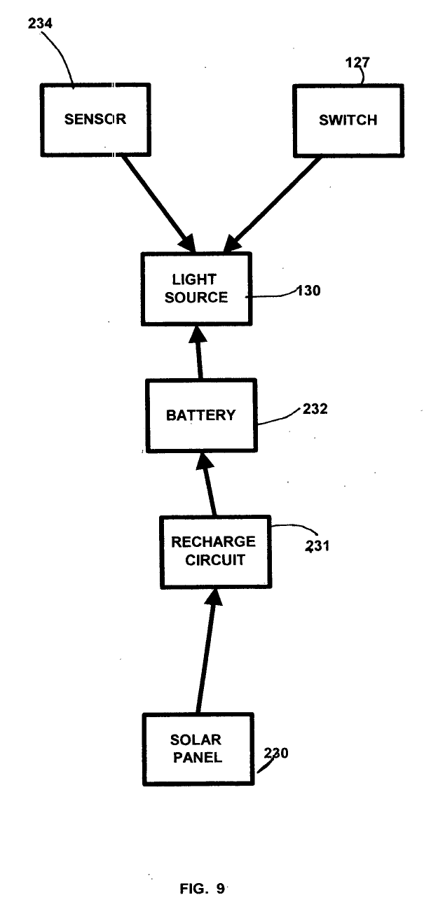

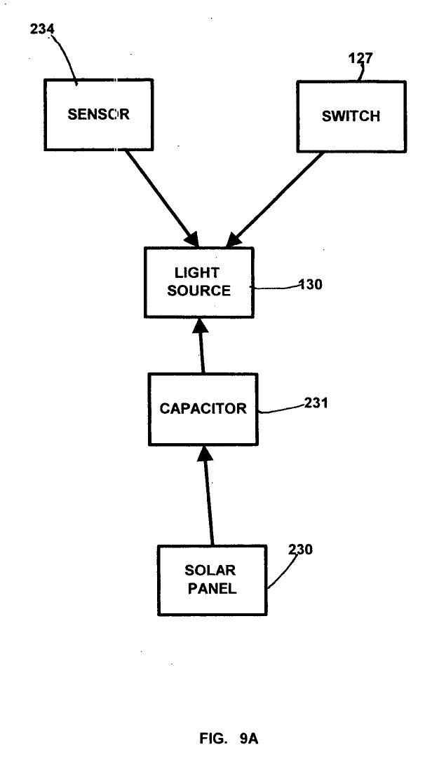

Batteries may be accommodated in a compartment (115) located in the fishing rod's handle (120). Electrical contacts, wiring, and a light source such as a light-bulb are placed within this compartment (115) as well. The base of the handle (120) can accommodate a battery cap (125). Once the battery cap (125) is removed, batteries (such as AA, AAA, and so on) are inserted through the handle's base. Further, a connector switch (127) located on the surface of the handle (120) connects the batteries to the light source (130). In the preferred embodiment of the present invention, the connector switch (127) as well as the battery cap is water proof. In alternative embodiments, a sensor (234) can be operationally connected to connector switch 127. In this embodiment, sensor (234) would detect night fall and automatically turn on light source 130, and connector switch 127 would function as a manual override switch (as shown in FIG. 9). Thus, in use if there is a problem with sensor 234, connector switch 127 would be use to manually switch light source 130 on or off.

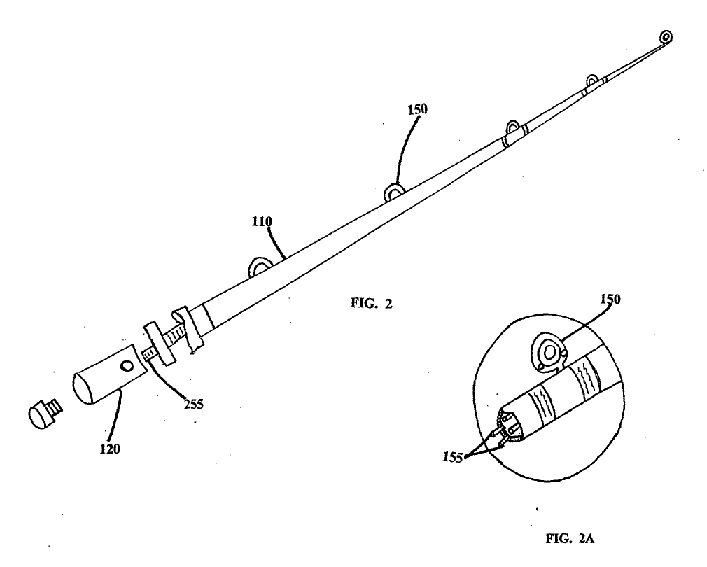

A light bulb can be accommodated as a light source at the forward end of the compartment (115) inside the handle (120). The light bulb can be comprised of several different colors, depending on the preference of the user. In the preferred embodiment, the bulb would consist of a lighter color in order to provide clearer illumination. The size of the light bulb used may be dependant on the overall size of the fishing rod. As shown in FIG. 2, a lens (255), which can be of different colors, can be integrated into the flashlight within handle (120). The light source can also be an LED, laser light, or a black light.

The outer shaft (110) of the fishing rod (100) can accommodate a plurality of circular eyelet guide members (150) as shown in FIG. 1 extending the length of the rod to its tip. The eyelet members (150) are mounted on the external surface of the rod. Each eyelet is hollow and may be transparent or translucent. The eyelets (150) may be constructed of any suitable rigid material such as plastic, glass, Plexiglas, and so on.

Referring to FIG. 1A, an aggregate of optical fibers (170) forms a bundle that extends the length of the fishing rod, (i.e., from the handle to the tip of the rod). As shown in FIG. 2A, in some embodiments, the fibers can be accommodated by one or more conduits (155) that run inside the shaft of the rod. Further, as shown in FIG. 1A the hollow interior of each eyelet member (150) can accommodate at least one optical fiber which diverges from the aggregate of fibers to light the eyelet. At least one strand of fiber from the bundle of fibers extends through an aperture (151) located below each eyelet member (150). The strand of fiber extends through each eyelet member (150) for the illumination thereof. A tip section (160) of the rod may be constructed of clear translucent, or fluorescent material which is also lighted by the optical fibers (170). The fishing pole can be illuminated in a variety of ways such as:
the tip only can be illuminated
the pole only can be illuminated
the eye guide only can be illuminated
any combination of the above can be combined to illuminate the pole 5.

In use, referring to FIG. 1, a user may activate the fishing rod (100) by switching on the connector switch (127). This connects the batteries which cause an electrical current to flow through the wires, causing the bulb to light. Consequently, the bulb transmits light to the optical fibers. As a result, a glow emanates from the plurality of eyelets along the length of the rod, and from the rod tip section. The emanating glow lights up the rod and the surrounding space of the user, thus making it possible to see these clearly in a low-light or darkened setting. In an alternative embodiment, fiber optics can be replaced with LEDS. In this embodiment the LEDS would be incorporated into the eyelet guides and/or mounted on the interior or exterior of the shaft.

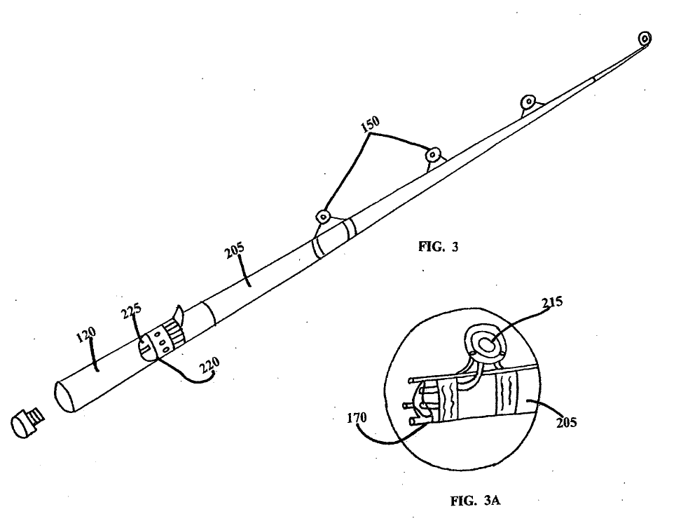

In an alternative embodiment of the present invention shown in FIG. 3A, a plurality of optical fibers (170) are coupled to the outer surface of the shaft (205) of the fishing rod. Additionally, the optical fibers running on the outside of the shaft (205) of the rod may be wrapped or dipped in a sealant (i.e., an epoxy sealant or resin or another suitable sealant) in order to prevent damage to the fibers.

As shown in FIG. 3, in another embodiment of the present invention, the handle (120) can be detached from the shaft (205) of the fishing rod and used as a flashlight. The handle (120) can be decoupled from shaft (205) using conventional male and female couplers (225). The power source of the portable flashlight can be rechargeable battery, solar cells, magnetic power source, or ac/dc adapter.

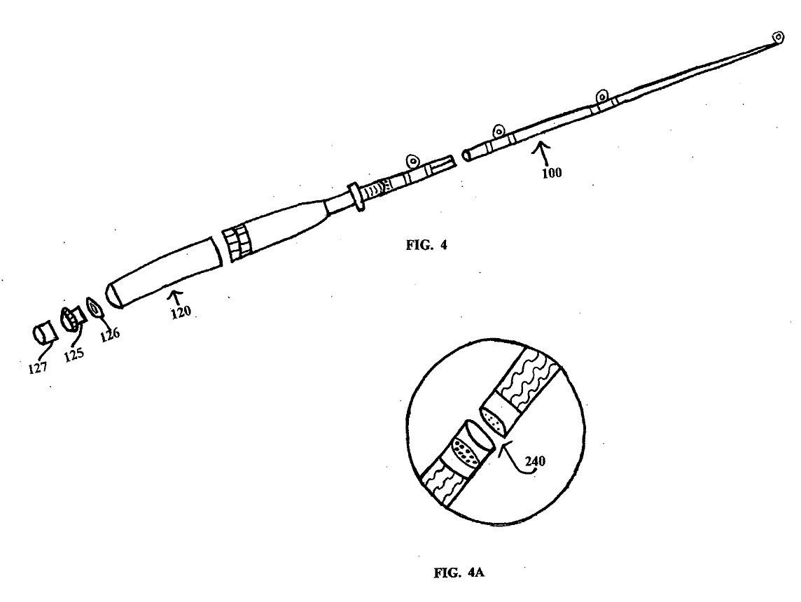

Referring to FIG. 4, once the handle (120) is decoupled as a flashlight, a separate cap (127) is needed to secure the shaft of the rod (100). As depicted in FIGS. 9 AND 9A, solar panel (230) can be incorporated into the exterior surface of the handle (120). In FIG. 9, solar panel (230) can then be operationally connected to the batteries which provide an electric current for powering the light source 130. In this embodiment, solar panel 230 is connected to a recharge circuit 231 which captures the electricity generated by solar panel 230. Recharge circuit 231 which connected to battery 231 is adapted to charge battery 234. In FIG. 9A solar panel 230 can be operationally to a capacitor 231 which provide which provide an electric current for powering the light source 130.

In some embodiments, the light source can be a black light bulb which creates a fluorescent rod and makes the fishing line glow. Further, the eyelets may be treated with a substance that enables them to glow in the dark, which would allow for some vision while preserving the batteries.

Referring to FIG. 4, fishing rod (100) may also be constructed in multiple sections that can be disconnected when the rod is stored. As shown in FIG. 4A, optical couplers (240) may be utilized at the joints to retain the optical fibers in place and to align the optical fibers, thus ensuring that all the eyelets light up when the rod is reconnected.

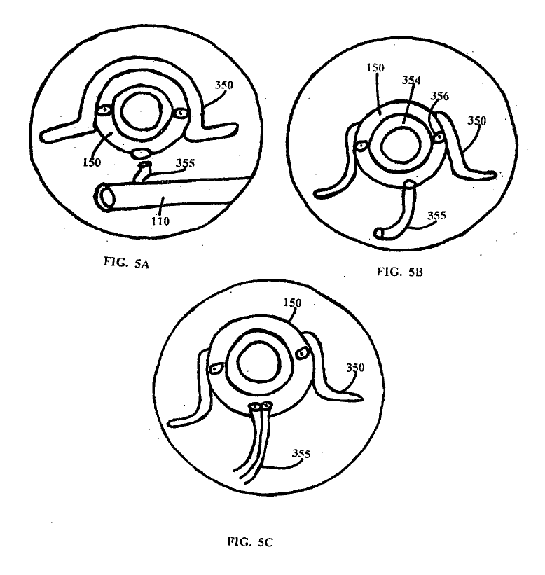

Referring to FIGS. 5A, 5B, and 5C, in some embodiments, the plurality of eyelet members (150) can be removably mounted onto the outer shaft of the fishing rod from its distal end to its proximal end. Each eyelet member is securely attached to the outer shaft using a support bracket (350) that is adapted to securely attach to the outer shaft (110). The support bracket (350) can surround the eyelet member (150) as shown in FIG. 5A or can be bifurcated as shown in FIG. 5B.

As shown in FIGS. 5A, 5B, and 5C optical connecting member (355) operationally interconnects the optical strands contained within the eyelet member (150) to the fiber optical bundle internally mounted within the shaft (110) or externally mounted upon the shaft (110). Optical connecting member (355) provides a sustained electrical current such that each connected eyelet member (150) can be illuminated.

As shown in FIG. 5B, in some embodiments, each eyelet member further includes a second circular member (354) co-centrically located within each eyelet member. The second circular member can be made of ceramic, mirror or another suitable material. In even more specific embodiments, a mirror (356) can be located on the outer surface area of each eyelet member.

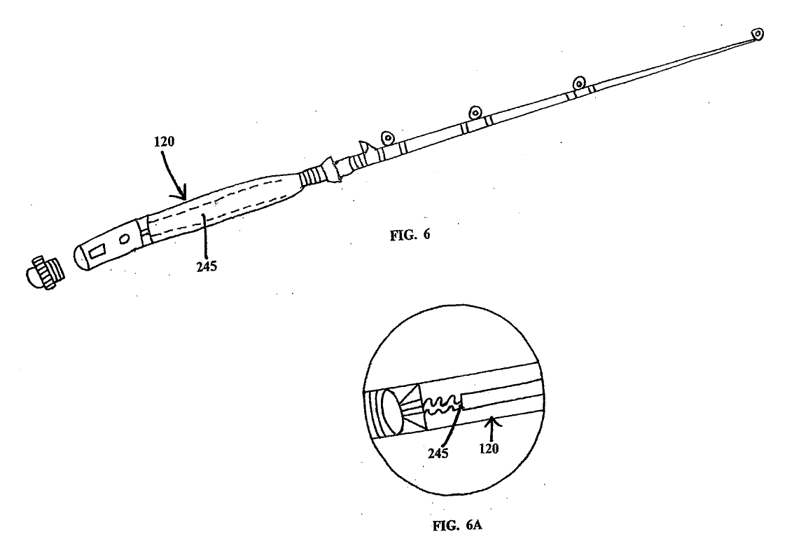

Referring to FIGS. 6 and 6A, handle (120) may be constructed with a telescoping extension rod (245). Telescoping rod (245) allows the user to adjust the length of handle (120) to a comfortable length.

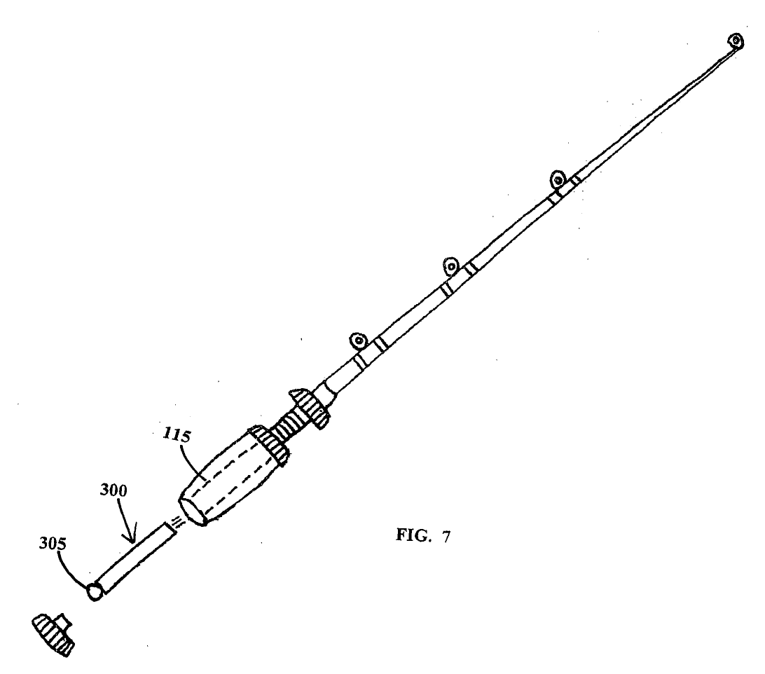

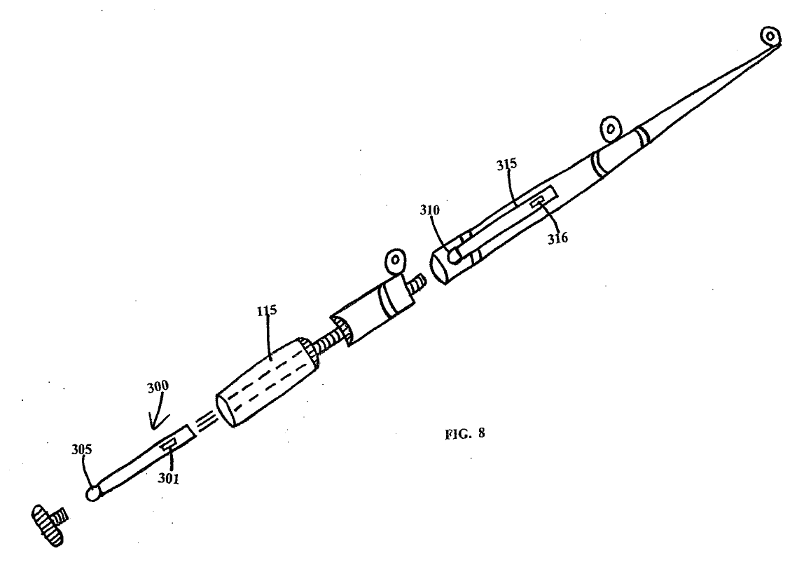

Referring to FIG. 7, compartment (115) can be adapted to contain a mini-flashlight (300) that can be removed for external use. Mini-flashlight (300) is sized to fit within compartment (115). Attached to one end of mini-flashlight (300) is a finger ring (305) that allows the user to remove the mini-flashlight (300) from compartment (115).

As illustrated in FIG. 8, a second light source separate from the handle can be accommodated within the interior or exterior of the shaft of the rod. The second light source can be a laser light or LED's. Additionally, the second light source can be powered by a separate battery power unit. In yet other embodiments, the transparent eyelet guide members can be accommodated with a magnifying lens for magnification of the optical light.

It is to be understood that even though numerous characteristics and advantages of the present invention have been set forth in the foregoing description, the disclosure is illustrative only, and changes may be made in detail, especially in matters of size, shape and arrangement of parts within the principles of the invention.

1. An illuminated fishing rod comprising:
an elongated shaft defined by a first end and a handle at the opposite second end, the shaft having an internal bore;
a tip portion adjoined to the first end;
a compartment within the handle, the compartment adapted to accommodate a power source and a light source, the light source operationally connected to the power source;
at least one hollow eyelet guide member externally mounted along the longitudinal axis of the shaft;
a bundle of optical fibers mounted inside the bore of the shaft extending from the first end to the opposite second end, the bundle of optical fibers being operationally connected to the light source;

2. The fishing rod of claim 1 wherein the at least one guide member further comprises an aperture located below each guide member for receiving therethrough at least one optical strand from the bundle, the at least one strand extending through the guide member for the illumination thereof.

3. The fishing rod of claim 1 wherein the power source is a battery.

4. The fishing rod of claim 3 wherein the power source further comprises:
a solar panel attached to the outer surface of the shaft or handle; and
the solar panel operational connected to the battery for recharging.

5. The fishing rod of claim 1 wherein the light source is a LED.

6. The fishing rod of claim 1 wherein the light source is a laser light or a black light.

7. The fishing rod of claim 1 or 2 wherein:
the tip portion is adapted to receive at least one optical strand from the bundle for the illumination thereof; and
the tip portion is made of a transparent, translucent or fluorescent material.

8. The fishing rod of claim 1 further comprising a timer for controlling the length of time the light source will be illuminated.

9. The fishing rod of claim 1 wherein the shaft is made of a transparent, translucent, or florescent material.

10. The fishing rod of claim 1 wherein the at least one eyelet guide member is made of a transparent, translucent, or florescent material.

11. The fishing rod of claim 10 wherein at least one eyelet guide member is adapted with a mirror mounted upon an external surface area.

12. The fishing rod of claim 10 wherein the at least one eyelet guide member further comprises a magnifying lens mounted upon an external surface area for magnifying the fiber optic light.

13. (canceled)

14. The fishing rod of claim 1 wherein the at least one eyelet guide member is removabely mounted upon the exterior surface of the shaft

15. (canceled)

16. The fishing rod of claim 1 wherein the shaft further comprises:
a plurality of internal conduits within the inner wall of the shaft;
the conduits extending from the first end to the opposite second end; and
each internal conduit adapted to accommodate a portion of the bundle of optical fibers.

17. The fishing rod of claim 1 wherein:
the handle is detachable from the shaft;
and adapted to operate as a portable flashlight.

18. (canceled)

19. The fishing rod of claim 1 further comprising a second light source operationally mounted upon the exterior surface of the shaft or interiorly mounted within the bore of the shaft.

20. The fishing rod of claim 19 wherein the second light source is a LED, laser light, or a blacklight.

21. The fishing rod of claim 1 further comprising:
a telescopic rod internally mounted for adjusting the length of the rod; and
the telescopic rod being internally mounted within the bore of the shaft near the handle;

22. (canceled)

23. An illuminated fishing rod comprising:
an elongated shaft defined by a first end and a handle at the opposite second end;
a tip portion adjoined to the first end;
a compartment within the handle, the compartment adapted to receive a power source and a light source, the light source operationally connected to the power source;
at least one hollow eyelet guide members externally mounted along the longitudinal axis of the shaft from the first end to the opposite second end;
a bundle of optical fibers externally mounted along the outer surface the shaft, the fibers extending from the first end to the opposite second end,
the bundle of optical fibers being operationally connected to the light source; and

24. The fishing rod of claim 23 wherein the at least one guide member is adapted to receive at least one optical strand from the bundle for the illumination thereof.

25. The fishing rod of claim 23 wherein the bundle of fibers being wrapped in a sealant for protecting the fibers against damage.

26. The fishing rod of claim 24 wherein:
the tip portion is adapted to receive at least one optical strand from the bundle for the illumination thereof; and
the tip portion is made of a transparent, translucent or fluorescent material.

27. The fishing rod of claim 23 wherein:
the handle is detachable from the shaft;
and adapted to operate as a portable flashlight.

28. The fishing rod of claim 23 wherein:
the compartment of the handle is adapted to contain a removable mini-flashlight;
and a finger ring attached to the mini-flashlight for removing the mini-flashlight from the compartment.

29. An illuminated fishing rod comprising:
an elongated shaft defined by a first end and a handle at the opposite second end, the shaft having a plurality of interconnecting sections, each section having an internal bore;
a tip portion adjoined to the first end;
an optical coupler attached at each end of each section, the coupler for interconnecting each section to form the shaft;
a compartment within the handle, the compartment adapted to receive a power source and a light source, the light source operationally connected to the power source;
at least one hollow eyelet guide members externally mounted along the longitudinal axis of each section of the shaft;
a bundle of optical fibers inside each bore of section, the bundle of optical fibers being operationally connected to each optical coupler at each end, the bundle of optical fibers being operationally connected to the light source;
an aperture located below each guide for receiving therethrough at least one optical strand from the bundle, the at least one strand extending through the guide member for the illumination thereof and the tip portion and the handle having an optical coupler at one end, the optical coupler for interconnecting with the plurality of sections to form the shaft of the fishing rod.

30. The fishing rod of claim 29 wherein the at least one guide member further comprises an aperture located below each guide for receiving therethrough at least one optical strand from the bundle, the at least one strand extending through the guide member for the illumination thereof.

31. The fishing rod of claim 30 wherein:
the tip portion is adapted to receive at least one optical strand from the bundle for the illumination thereof; and
the tip portion is made of a transparent, translucent or fluorescent material.

32. The fishing rod of claim 29 wherein:
the handle is detachable from the shaft;
and adapted to operate as a portable flashlight.

33. The fishing rod of claim 29 wherein:
the compartment of the handle is adapted to contain a removable mini-flashlight;
and a finger ring attached to the mini-flashlight for removing the mini-flashlight from the compartment.
